(19) United States
(12) Patent Application Publication
(10) Pub. No.: US 2024/0391829 A1
(43) Pub. Date: Nov. 28, 2024

(54) BUILDING MATERIALS COMPRISING AGGLOMERATED PARTICLES WITH EMBEDDED PIGMENT

(71) Applicant: Specialty Granules Investments LLC, Parsippany, NJ (US)

(72) Inventor: Peter Wilson, Knoxville, MD (US)

(21) Appl. No.: 18/671,427

(22) Filed: May 22, 2024

Related U.S. Application Data
(60) Provisional application No. 63/503,762, filed on May 23, 2023.

(51) Int. Cl. C04B 18/02; C04B 14/14; C04B 18/12; C04B 103/54; C04B 111/00

(52) U.S. Cl. CPC C04B 18/021; C04B 14/14; C04B 18/12; C04B 2103/54; C04B 2111/00594

(57) ABSTRACT

Colored roofing granules comprising agglomerated inorganic material with embedded pigment, and building materials, such as roofing shingles, that include such colored roofing granules. By fabricating colored roofing granules from agglomerating inorganic material it is possible to tailor the particle size distribution so as to provide optimal shingle surface coverage, thus reducing shingle weight and usage of raw materials. Additionally, agglomeration of inorganic material with embedded pigment, including colored rock fines and/or colored mineral fines, permits the utilization of by-products from conventional granule production processes, including a waste stream of pigment.

This application claims the priority of U.S. provisional application Ser. No. U.S. 63/503,762 entitled “Building Materials Comprising Agglomerated Particles with Embedded Pigment” filed May 23, 2023, which is incorporated herein by reference in its entirety for all purposes.

### FIELD OF THE INVENTION

The invention relates to building materials (such as roofing shingles) that include colored roofing granules comprising agglomerated inorganic material with embedded pigment. The invention also relates to colored roofing granules comprising agglomerated inorganic material with embedded pigment. By fabricating roofing granules from agglomerated inorganic material, it is possible to tailor the particle size distribution so as to provide improved surface coverage for roofing products, thus reducing roofing product weight and usage of raw materials. Additionally, agglomeration of inorganic material with embedded pigment, including colored rock fines and/or colored mineral fines, permits the utilization of by-products from conventional granule production processes, including a waste stream of pigment.

### BACKGROUND OF THE INVENTION

When crushing and screening rock to produce roofing granules, significant quantities of fine by-product are produced that are too small for roofing granules. Fines are also generated in coloring plant operations, the results of which are heavily tinted with pigments from the granule painting operations.

There is thus a need to utilize such waste streams of fine by-product, including a waste stream of pigmented fines, which allows for the preparation of building materials that can include colored roofing granules.

### SUMMARY OF THE INVENTION

One embodiment of this invention pertains to a method comprising: obtaining (i) at least one of rock fines, mineral fines, or a combination thereof, (ii) at least one of a pigment, colored rock fines, colored mineral fines, or a combination thereof, and (iii) a binder; and mixing (i) the at least one of rock fines, mineral fines, or a combination thereof, (ii) the at least one of a pigment, colored rock fines, colored mineral fines, or a combination thereof, and (iii) the binder, to produce colored agglomerated particles.

In one embodiment, the colored rock fines, the colored mineral fines, or a combination of the colored rock fines and the colored mineral fines is obtained from a waste stream from granule painting operations.

In one embodiment, the pigment is added at a loading rate of 1 wt % to 10 wt % based on a dry mass of the colored agglomerated particles.

In one embodiment, the colored rock fines, the colored mineral fines, or a combination of the colored rock fines and the colored mineral fines is added at a loading rate of 1 wt % to 100 wt % based on a dry mass of the colored agglomerated particles.

In one embodiment, the at least one of rock fines, mineral fines, or a combination thereof is added in an amount of 50 wt % to 95 wt % with respect to a total dry weight of the colored agglomerated particles. In one embodiment, the at least one of rock fines, mineral fines, or a combination thereof is added in an amount of 70 wt % to 90 wt % with respect to a total dry weight of the colored agglomerated particles.

In one embodiment, the pigment is added in an amount of 1 wt % to 50 wt % with respect to a total dry weight of the colored agglomerated particles. In one embodiment, the pigment is added in an amount of 10 wt % to 30 wt % with respect to a total dry weight of the colored agglomerated particles.

In one embodiment, the binder is added in an amount of 1 wt % to 15 wt % with respect to a total weight of the colored agglomerated particles. In another embodiment, the binder is added in an amount of 5 wt % to 12 wt % with respect to a total weight of the colored agglomerated particles.

In one embodiment, the at least one of rock fines, mineral fines, or a combination thereof comprises one or more of basalt, metabasalt, andesite, granite, and rhyolite. In another embodiment, the at least one of rock fines, mineral fines, or a combination thereof comprises metabasalt.

In one embodiment, the binder is at least one of sodium silicate, gypsum, or a combination thereof.

In one embodiment, the binder comprises sodium silicate.

In one embodiment, the colored agglomerated particles exhibit an L value, as measured by a Hunter L, a, and b color scale, that is from 20 to 30.

In one embodiment, the method further comprises applying the colored agglomerated particles to a sheet to form a roofing material.

In one embodiment, the roofing material is a roofing shingle or roll roofing.

In one embodiment, the mixing of (i) the at least one of rock fines, mineral fines, or a combination thereof, (ii) the at least one of a pigment, colored rock fines, colored mineral fines, or a combination thereof, and (iii) the binder is conducted to produce unsintered, colored agglomerated particles.

In one embodiment, the mixing uses a pin mixer.

In one embodiment, the method further comprises pelletizing the colored agglomerated particles.

In one embodiment, the method further comprises drying the colored agglomerated particles.

In one embodiment, the colored agglomerated particles have a particle size distribution comprising (1) at least about 30 wt % retained by Tyler Mesh 20 after passing Tyler Mesh 14, (2) at least about 10 wt % retained by Tyler Mesh 28 after passing Tyler Mesh 20, and (3) at least about 5 wt % retained by Tyler Mesh 35 after passing Tyler Mesh 28.

In another embodiment, the colored agglomerated particles have a particle size distribution comprising (1) at least about 40 wt % retained by Tyler Mesh 20 after passing Tyler Mesh 14, (2) at least about 20 wt % retained by Tyler Mesh 28 after passing Tyler Mesh 20, and (3) at least about 10 wt % retained by Tyler Mesh 35 after passing Tyler Mesh 28.

Another embodiment of this invention pertains to a method comprising obtaining (i) at least one of rock fines, mineral fines, or a combination thereof, (ii) a waste pigment material comprising colored rock fines, colored mineral fines, or a combination thereof, and (iii) a binder, and mixing (i) the at least one of rock fines, mineral fines, or a combination thereof, (ii) the waste pigment material, and (iii) the binder, to produce colored agglomerated particles.

In one embodiment, the waste pigment material is obtained from a waste stream from granule painting operations.

In one embodiment, the waste pigment material has an average particle size that is larger than that of a virgin pigment.

In one embodiment, the waste pigment material comprises at least one of (i) clay materials, (ii) rock fines, mineral fines, or a combination thereof, (iii) one or more pigments, (iv) silicates, or (v) a combination thereof.

In one embodiment, the waste pigment material comprises more than 1 wt % of at least one of sodium (Na), magnesium (Mg), aluminum (Al), or silicon (Si).

In one embodiment, the waste pigment material is added at a loading rate of 1 wt % to 100 wt % based on a dry mass of the colored agglomerated particles.

In one embodiment, the at least one of rock fines, mineral fines, or a combination thereof is added in an amount of 50 wt % to 95 wt % with respect to a total dry weight of the colored agglomerated particles. In one embodiment, the at least one of rock fines, mineral fines, or a combination thereof is added in an amount of 70 wt % to 90 wt % with respect to a total dry weight of the colored agglomerated particles.

In one embodiment, the binder is added in an amount of 1 wt % to 15 wt % with respect to a total weight of the colored agglomerated particles. In another embodiment, the binder is added in an amount of 5 wt % to 12 wt % with respect to a total weight of the colored agglomerated particles.

In one embodiment, the at least one of rock fines, mineral fines, or a combination thereof comprises one or more of basalt, metabasalt, andesite, granite, and rhyolite. In another embodiment, the at least one of rock fines, mineral fines, or a combination thereof comprises metabasalt.

In one embodiment, the binder is at least one of sodium silicate, gypsum, or a combination thereof.

In one embodiment, the binder comprises sodium silicate.

In one embodiment, the method further comprises adding a pigment to produce the colored agglomerated particles. In one embodiment, the pigment is added in an amount of 1 wt % to 50 wt % with respect to a total dry weight of the colored agglomerated particles.

In one embodiment, the colored agglomerated particles exhibit an L value, as measured by a Hunter L, a, and b color scale, that is from 20 to 30.

In one embodiment, the method further comprises applying the colored agglomerated particles to a sheet to form a roofing material.

In one embodiment, the roofing material is a roofing shingle or roll roofing.

In one embodiment, the mixing of (i) the at least one of rock fines, mineral fines, or a combination thereof, (ii) the waste pigment material, and (iii) the binder is conducted to produce unsintered, colored agglomerated particles.

In one embodiment, the mixing uses a pin mixer.

In one embodiment, the method further comprises pelletizing the colored agglomerated particles.

In one embodiment, the method further comprises drying the colored agglomerated particles.

In one embodiment, the colored agglomerated particles have a particle size distribution comprising (1) at least about 30 wt % retained by Tyler Mesh 20 after passing Tyler Mesh 14, (2) at least about 10 wt % retained by Tyler Mesh 28 after passing Tyler Mesh 20, and (3) at least about 5 wt % retained by Tyler Mesh 35 after passing Tyler Mesh 28.

In another embodiment, the colored agglomerated particles have a particle size distribution comprising (1) at least about 40 wt % retained by Tyler Mesh 20 after passing Tyler Mesh 14, (2) at least about 20 wt % retained by Tyler Mesh 28 after passing Tyler Mesh 20, and (3) at least about 10 wt % retained by Tyler Mesh 35 after passing Tyler Mesh 28.

Another embodiment of this invention pertains to a colored roofing granule comprising colored agglomerated particles comprising (i) at least one of a rock, a mineral, or a combination thereof, (ii) at least one of a pigment, colored rock fines, colored mineral fines, or a combination thereof, and (iii) a binder.

In one embodiment, the colored rock fines, the colored mineral fines, or a combination of the colored rock fines and the colored mineral fines is obtained from a waste stream from granule painting operations.

In one embodiment, the colored agglomerated particles are unsintered.

In one embodiment, the pigment is present in an amount of 1 wt % to 10 wt % with respect to a total dry weight of the colored agglomerated particles.

In one embodiment, the colored rock fines, the colored mineral fines, or a combination of the colored rock fines and the colored mineral fines is present in an amount of 1 wt % to 100 wt % with respect to a total dry weight of the colored agglomerated particles.

In one embodiment, the at least one of rock fines, mineral fines, or a combination thereof is present in an amount of 50 wt % to 95 wt % with respect to a total dry weight of the colored agglomerated particles. In one embodiment, the at least one of rock fines, mineral fines, or a combination thereof is present in an amount of 70 wt % to 90 wt % with respect to a total dry weight of the colored agglomerated particles.

In one embodiment, the pigment is present in an amount of 1 wt % to 50 wt % with respect to a total dry weight of the colored agglomerated particles. In one embodiment, the pigment is present in an amount of 10 wt % to 30 wt % with respect to a total dry weight of the colored agglomerated particles.

In one embodiment, the binder is present in an amount of 1 wt % to 15 wt % with respect to a total weight of the colored agglomerated particles. In another embodiment, the binder is present in an amount of 5 wt % to 12 wt % with respect to a total weight of the colored agglomerated particles.

In one embodiment, the at least one of a rock, a mineral, or a combination thereof comprises one or more of basalt, metabasalt, andesite, granite, and rhyolite. In another embodiment, the at least one of a rock, a mineral, or a combination thereof comprises metabasalt.

In one embodiment, the binder is at least one of sodium silicate, gypsum, or a combination thereof.

In one embodiment, the binder comprises sodium silicate.

In one embodiment, the colored agglomerated particles exhibit an L value, as measured by a Hunter L, a, and b color scale, that is from 20 to 30.

Another embodiment of this invention pertains to a colored roofing granule comprising colored agglomerated particles comprising (i) at least one of a rock, a mineral, or a combination thereof, (ii) a waste pigment material comprising colored rock fines, colored mineral fines, or a combination thereof, and (iii) a binder.

In one embodiment, the waste pigment material is obtained from a waste stream from granule painting operations.

In one embodiment, the waste pigment material has an average particle size that is larger than that of a virgin pigment.

In one embodiment, the waste pigment material comprises at least one of (i) clay materials, (ii) rock fines, mineral fines, or a combination thereof, (iii) one or more pigments, (iv) silicates, or (v) a combination thereof.

In one embodiment, the waste pigment material comprises more than 1 wt % of at least one of sodium (Na), magnesium (Mg), aluminum (Al), or silicon (Si).

In one embodiment, the waste pigment material is added at a loading rate of 1 wt % to 100 wt % based on a dry mass of the colored agglomerated particles.

In one embodiment, the colored agglomerated particles are unsintered.

In one embodiment, the at least one of rock fines, mineral fines, or a combination thereof is present in an amount of 50 wt % to 95 wt % with respect to a total dry weight of the colored agglomerated particles. In one embodiment, the at least one of rock fines, mineral fines, or a combination thereof is present in an amount of 70 wt % to 90 wt % with respect to a total dry weight of the colored agglomerated particles.

In one embodiment, the binder is present in an amount of 1 wt % to 15 wt % with respect to a total weight of the colored agglomerated particles. In another embodiment, the binder is present in an amount of 5 wt % to 12 wt % with respect to a total weight of the colored agglomerated particles.

In one embodiment, the at least one of a rock, a mineral, or a combination thereof comprises one or more of basalt, metabasalt, andesite, granite, and rhyolite. In another embodiment, the at least one of a rock, a mineral, or a combination thereof comprises metabasalt.

In one embodiment, the binder is at least one of sodium silicate, gypsum, or a combination thereof.

In one embodiment, the binder comprises sodium silicate.

In one embodiment, the colored agglomerated particles exhibit an L value, as measured by a Hunter L, a, and b color scale, that is from 20 to 30.

Yet another embodiment of this invention pertains to a roofing material comprising colored agglomerated particles comprising (a) at least one of a rock, a mineral, or a combination thereof, (b) at least one of a pigment, colored rock fines, colored mineral fines, or a combination thereof, and (c) a binder.

In one embodiment, the colored rock fines, the colored mineral fines, or a combination of the colored rock fines and the colored mineral fines is obtained from a waste stream from granule painting operations.

In one embodiment, the roofing material comprises a roofing shingle or roll roofing.

In one embodiment, the colored agglomerated particles are unsintered.

In one embodiment, the pigment is present in an amount of 1 wt % to 10 wt % with respect to a total dry weight of the colored agglomerated particles.

In one embodiment, the colored rock fines, the colored mineral fines, or a combination of the colored rock fines and the colored mineral fines is present in an amount of 1 wt % to 100 wt % with respect to a total dry weight of the colored agglomerated particles.

In one embodiment, the at least one of rock fines, mineral fines, or a combination thereof is present in an amount of 50 wt % to 95 wt % with respect to a total dry weight of the colored agglomerated particles. In one embodiment, the at least one of rock fines, mineral fines, or a combination thereof is present in an amount of 70 wt % to 90 wt % with respect to a total dry weight of the colored agglomerated particles.

In one embodiment, the pigment is present in an amount of 1 wt % to 50 wt % with respect to a total dry weight of the colored agglomerated particles. In one embodiment, the pigment is present in an amount of 10 wt % to 30 wt % with respect to a total dry weight of the colored agglomerated particles.

In one embodiment, the binder is present in an amount of 1 wt % to 15 wt % with respect to a total weight of the colored agglomerated particles. In another embodiment, the binder is present in an amount of 5 wt % to 12 wt % with respect to a total weight of the colored agglomerated particles.

In one embodiment, the at least one of a rock, a mineral, or a combination thereof comprises one or more of basalt, metabasalt, andesite, granite, and rhyolite. In another embodiment, the at least one of a rock, a mineral, or a combination thereof comprises metabasalt.

In one embodiment, the binder is at least one of sodium silicate, gypsum, or a combination thereof.

In one embodiment, the binder comprises sodium silicate.

In one embodiment, the colored agglomerated particles exhibit an L value, as measured by a Hunter L, a, and b color scale, that is from 20 to 30.

Yet another embodiment of this invention pertains to a roofing material comprising colored agglomerated particles comprising (a) at least one of a rock, a mineral, or a combination thereof, (b) a waste pigment material comprising colored rock fines, colored mineral fines, or a combination thereof, and (c) a binder.

In one embodiment, the waste pigment material is obtained from a waste stream from granule painting operations.

In one embodiment, the waste pigment material has an average particle size that is larger than that of a virgin pigment.

In one embodiment, the waste pigment material comprises at least one of (i) clay materials, (ii) rock fines, mineral fines, or a combination thereof, (iii) one or more pigments, (iv) silicates, or (v) a combination thereof.

In one embodiment, the waste pigment material comprises more than 1 wt % of at least one of sodium (Na), magnesium (Mg), aluminum (Al), or silicon (Si).

In one embodiment, the roofing material comprises a roofing shingle or roll roofing.

In one embodiment, the colored agglomerated particles are unsintered.

In one embodiment, the waste pigment material is added at a loading rate of 1 wt % to 100 wt % based on a dry mass of the colored agglomerated particles.

In one embodiment, the at least one of rock fines, mineral fines, or a combination thereof is present in an amount of 50 wt % to 95 wt % with respect to a total dry weight of the colored agglomerated particles. In one embodiment, the at least one of rock fines, mineral fines, or a combination thereof is present in an amount of 70 wt % to 90 wt % with respect to a total dry weight of the colored agglomerated particles.

In one embodiment, the binder is present in an amount of 1 wt % to 15 wt % with respect to a total weight of the colored agglomerated particles. In another embodiment, the binder is present in an amount of 5 wt % to 12 wt % with respect to a total weight of the colored agglomerated particles.

In one embodiment, the at least one of a rock, a mineral, or a combination thereof comprises one or more of basalt, metabasalt, andesite, granite, and rhyolite. In another embodiment, the at least one of a rock, a mineral, or a combination thereof comprises metabasalt.

In one embodiment, the binder is at least one of sodium silicate, gypsum, or a combination thereof.

In one embodiment, the binder comprises sodium silicate.

In one embodiment, the colored agglomerated particles exhibit an L value, as measured by a Hunter L, a, and b color scale, that is from 20 to 30.

### BRIEF DESCRIPTION OF THE FIGURES

For a more complete understanding of the invention and the advantages thereof, reference is made to the following descriptions, taken in conjunction with the accompanying figure, in which:

FIG. 1 is a graph that illustrates the percent yield (or percentage retained) as compared to certain sieve sizes (Tyler Mesh) of various formulations of colored agglomerated particles prepared according to embodiments of the invention.

FIG. 2A is a scanning electron microscope (SEM) image of a TiO₂ (titanium dioxide) virgin pigment according to an embodiment of the invention.

FIG. 2B is a scanning electron microscope (SEM) image of an iron oxide (or black) virgin pigment according to an embodiment of the invention.

FIGS. 3A-3D are scanning electron microscope (SEM) images of pigment-containing fines obtained from a waste stream according to an embodiment of the invention.

FIG. 4. is a table illustrating quantitative results of elements contained within a TiO₂ (titanium dioxide) virgin pigment according to an embodiment of the invention.

FIG. 5 is a table illustrating quantitative results of elements contained within an iron oxide (or black) virgin pigment according to an embodiment of the invention.

FIG. 6 is a table illustrating quantitative results of elements contained within pigment-containing fines obtained from a waste stream according to an embodiment of the invention.

### DETAILED DESCRIPTION OF THE INVENTION

Among those benefits and improvements that have been disclosed, other objects and advantages of this disclosure will become apparent from the following description taken in conjunction with the accompanying figure. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though they may. Furthermore, the phrases “in another embodiment” and “in some other embodiments” as used herein do not necessarily refer to a different embodiment, although they may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, terms such as “comprising,” “including,” and “having” do not limit the scope of a specific claim to the materials or steps recited by the claim.

As used herein, the term “consisting of” limits the scope of a specific claim to the materials and steps recited by the claim.

As used herein, the term “weight percent” or “% by weight” means the percentage by weight of a component based upon a total weight of a virgin pigment, a waste pigment material, the colored agglomerated particles or the colored roofing granule, as applicable.

As used herein, the terms “roofing material” or “roofing product” include, but are not limited to, shingles, roll roofing, roofing membranes, including, e.g., waterproofing membranes, and underlayment.

As used herein, the terms “rock fines, mineral fines, or a combination thereof” generally refer to the materials that may form the bulk of the dry material for the agglomerated particles. These “rock fines, mineral fines, or a combination thereof” can be derived from waste streams that do not involve coloring operations and generally contain no pigment.

As used herein, the terms “colored rock fines, colored mineral fines, or a combination thereof” generally refer to rock or mineral fines derived from waste streams from coloring operations (e.g., granule painting operations), which are coated with pigment. These “colored rock fines, colored mineral fines, or a combination thereof” provide color and may be agglomerated as is, i.e., with or without any additional pigment or uncolored rock or mineral fines. These “colored rock fines, colored mineral fines, or a combination thereof” comprise waste pigment material that includes a combination of materials, including, e.g., clay materials, rock fines, mineral fines, one or more pigments, and/or silicates. In addition, these “colored rock fines, colored mineral fines, or a combination thereof” (e.g., waste pigment material) have an average particle size that is larger than that of a virgin pigment (e.g., an average particle size of 5 to 100 μm), given that they are comprised of a combination of materials derived from a waste stream from coloring operations (e.g., granule painting operations). As used herein, the term “pigment” refers to an additional pigment that may be used to bring the final agglomerated particles to their final target color.

As used herein, the term “virgin pigment” refers to a pigment that has not yet been used in any manner, including, e.g., a coloring operation (e.g., granule painting operation), and thus only consists of the pigment itself (e.g., TiO₂ (titanium dioxide) and/or iron oxide (or black) pigments). Accordingly, these “virgin pigments” are not obtained from a waste stream and have an average particle size that is smaller than that of a “waste pigment material” (e.g., an average particle size of 1 to 100 nm).

When crushing and screening rock to produce roofing granules, significant quantities of fine by-product are produced that are too small for roofing granules. Fines are also generated in coloring plant operations, the results of which are heavily tinted with pigments from the granule painting operations. An agglomerated pellet or granule can be made from this fine by-product and can be colored to a desired specification by pelletizing the rock fines along with either a powered pigment source or with the heavily colored rock fines from the aforementioned granule painting operations. The resulting agglomerated pellet or granule can be used for colored roofing granules. This pellet or granule may be lighter in weight than conventional roofing granules, which reduces the cost of freight for the resulting product. The resulting agglomerated pellet or granule may have color throughout its cross section, making it more resilient to damage and color fade.

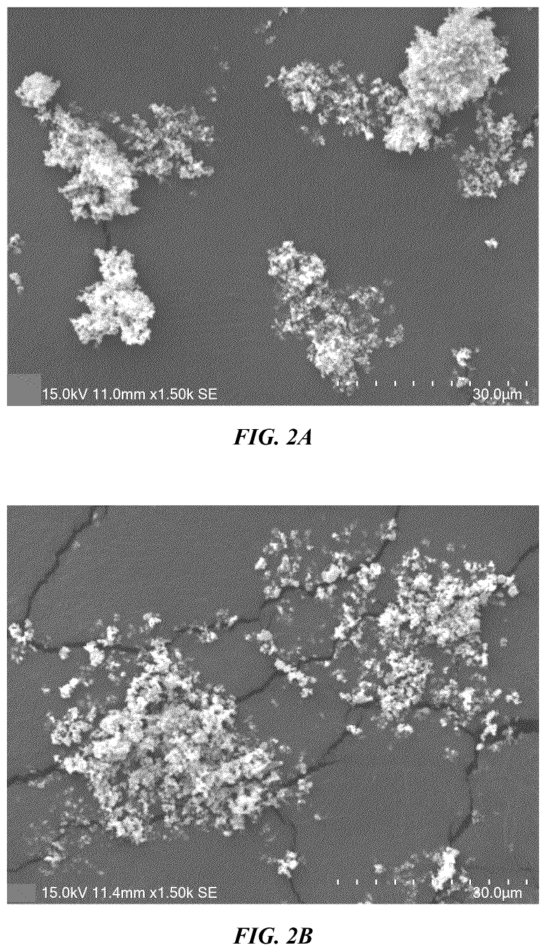

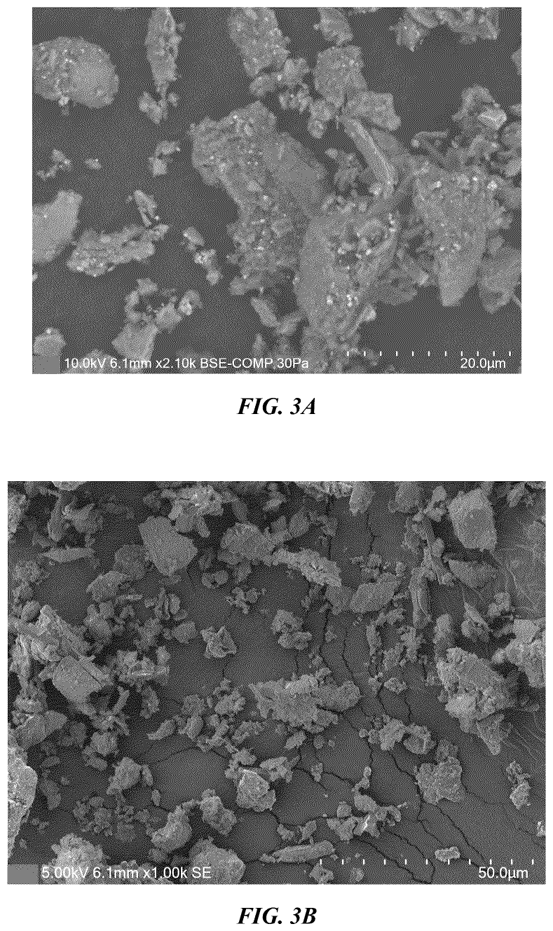

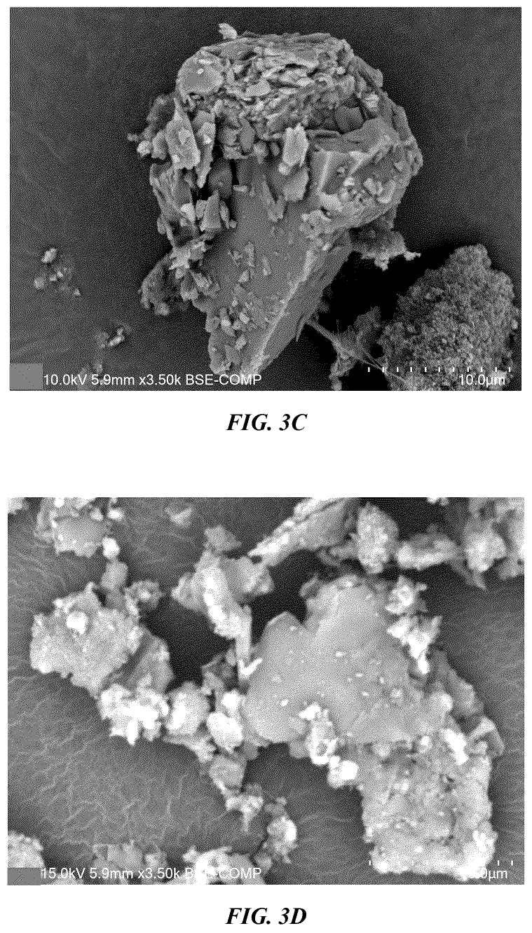

For example, fines generated in coloring plant operations (e.g., waste pigment material), the results of which are heavily tinted with pigments from granule painting operations, comprise property differences, compositional differences and/or particle size differences as compared to virgin pigments (e.g., TiO₂ or iron oxide) that are originally used to color or paint granules. In this regard, as shown in FIGS. 2A and 2B, SEM images for TiO₂ (titanium dioxide) and iron oxide (or black) virgin pigments are illustrated, respectively, which show the fine particle sizes of these virgin pigments, with the average particle size of these virgin pigments being around 1 to 100 nm. By contrast, as shown in FIGS. 3A-3D, which illustrate SEM images of pigment-containing fines obtained from a waste stream (i.e., pigment-containing or colored fines from a waste stream from granule painting operations), fines generated in coloring plant operations (e.g., waste pigment material) have much larger particle sizes (i.e., average particles sizes around 5 to 100 μm) as these pigment-containing fines (e.g., waste pigment materials) include other components beyond the waste pigment, such as, e.g., clay materials, mineral fines, a mixture of pigments, cured silicates, etc. Thus, fines generated in coloring plant operations (e.g., waste pigment material) have different particle sizes (as compared to virgin pigments) given that such waste pigment material includes a combination of materials bound together from the waste stream.

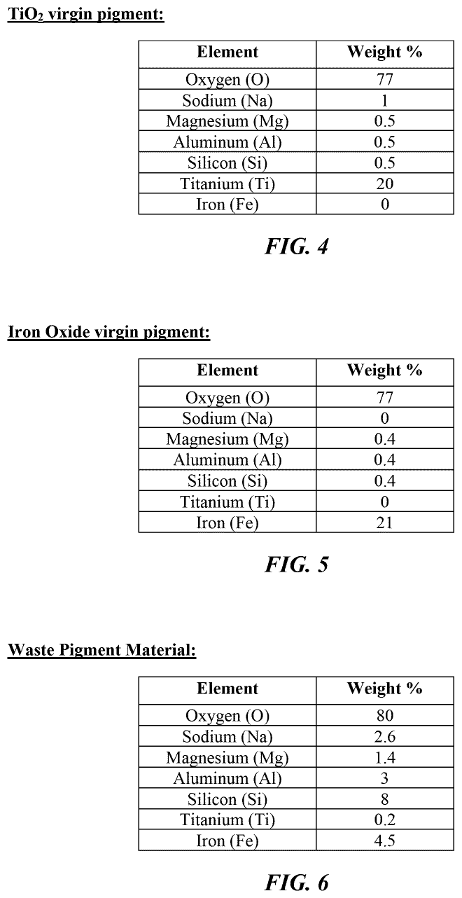

As another example, FIG. 4 is a table illustrating the quantitative results of elements contained within a TiO₂ (titanium dioxide) virgin pigment, while FIG. 5 is a table illustrating the quantitative results of elements contained within an iron oxide (or black) virgin pigment. As shown in FIG. 4, the TiO₂ (titanium dioxide) virgin pigment includes a variety of elements; however, the weight percent for oxygen (O) and titanium (Ti) comprises the majority of the elements (i.e., 77 weight % for oxygen and 20 weight % for titanium). In addition, as shown in FIG. 5, the iron oxide virgin pigment also includes a variety of elements, with the weight percent for oxygen (O) and iron (Fe) comprising the majority of the elements (i.e., 77 weight % for oxygen and 21 weight % for iron). By contrast, as shown in FIG. 6, which is a table illustrating the quantitative results of elements contained within pigment-containing fines obtained from a waste stream (i.e., pigment-containing or colored fines from a waste stream from granule painting operations), fines generated in coloring plant operations (e.g., waste pigment material) have different compositions and percentage of elements, including, e.g., a higher amount of oxygen (O) (i.e., 80 weight %), as well as a higher amount of other elements, including, e.g., sodium (Na) (i.e., 2.6 weight %), magnesium (1.4 weight %), aluminum (Al) (i.e., 3 weight %), and a silicon (Si) (i.e., 8 weight %), as compared to the negligible amount of these elements contained within the TiO₂ (titanium dioxide) and iron oxide virgin pigments. Thus, fines generated in coloring plant operations (e.g., waste pigment material) have different compositions (as compared to the virgin pigments), due to such waste pigment material including a combination of materials bound together from the waste stream.

In view of the foregoing, the instant disclosure relates to a colored roofing granule made from agglomerated rock fines and embedded pigment(s), which may be comprised of at least a waste stream of colored rock fines, color mineral fines, or a combination thereof. According to an aspect of the invention, agglomerated particles and/or roofing granules are prepared from pelletized rock fines and may be colored by incorporating a pigment within the pellet. This can be done by including the pigment with the rock fines in the pelletization step. The pigment may use pigment-containing or colored fines from a waste stream from granule painting operations, as discussed above.

### A. Colored Agglomerated Particles-Composition

In an embodiment, the colored agglomerated particles comprise (i) an inorganic material, (ii) at least one of a pigment, colored rock fines, colored mineral fines, or a combination thereof, and (iii) a binder. In another embodiment, the colored agglomerated particles comprise (i) an inorganic material, (ii) a waste pigment material comprising colored rock fines, colored mineral fines, or a combination thereof, and (iii) a binder. In an embodiment, the inorganic material comprises rock and/or mineral fragments (i.e., fragments of (a) rock and/or (b) mineral). In an embodiment, the rock and/or mineral fragments comprise fines and/or larger particle sizes.

In one embodiment, the rock and/or mineral fragments are of such a particle size as to pass Tyler Mesh 20. In other embodiments, the rock and/or mineral fragments are of such a particle size as to pass Tyler Mesh 4, or Tyler Mesh 6, or Tyler Mesh 8, or Tyler Mesh 10, or Tyler Mesh 14, or Tyler Mesh 20, or Tyler Mesh 28, or Tyler Mesh 35. Ranges based on any of the foregoing are also contemplated, e.g., the rock and/or mineral fragments may have particle sizes passing Tyler Mesh 4 but retained by Tyler Mesh 35.

Non-limiting examples of rock and/or mineral materials include igneous rocks such as basalt, andesite, granite, and rhyolite, amphibolite produced from the metamorphism of the basalt parent such as metabasalt, or combinations thereof—e.g., basalt and metabasalt; basalt and andesite.

In one embodiment, the colored rock fines, the colored mineral fines, or a combination of the colored rock fines and the colored mineral fines is obtained from a waste stream from granule painting operations (i.e., the colored rock fines, the colored mineral fines, or a combination thereof comprise waste pigment material).

In one embodiment, the pigment is added at a loading rate of 1 wt % to 10 wt % based on a dry mass of the colored agglomerated particles. In one embodiment, the pigment is added at a loading rate of 2 wt % to 10 wt % based on a dry mass of the colored agglomerated particles. In one embodiment, the pigment is added at a loading rate of 5 wt % to 10 wt % based on a dry mass of the colored agglomerated particles. In one embodiment, the pigment is added at a loading rate of 8 wt % to 10 wt % based on a dry mass of the colored agglomerated particles. In one embodiment, the pigment is added at a loading rate of 1 wt % to 5 wt % based on a dry mass of the colored agglomerated particles. In one embodiment, the pigment is added at a loading rate of 2 wt % to 5 wt % based on a dry mass of the colored agglomerated particles.

In one embodiment, the pigment is added at a loading rate of 1 wt % to 50 wt % based on a dry mass of the colored agglomerated particles. In one embodiment, the pigment is added at a loading rate of 5 wt % to 50 wt % based on a dry mass of the colored agglomerated particles. In one embodiment, the pigment is added at a loading rate of 10 wt % to 50 wt % based on a dry mass of the colored agglomerated particles. In one embodiment, the pigment is added at a loading rate of 20 wt % to 50 wt % based on a dry mass of the colored agglomerated particles. In one embodiment, the pigment is added at a loading rate of 30 wt % to 50 wt % based on a dry mass of the colored agglomerated particles. In one embodiment, the pigment is added at a loading rate of 40 wt % to 50 wt % based on a dry mass of the colored agglomerated particles. In one embodiment, the pigment is added at a loading rate of 1 wt % to 40 wt % based on a dry mass of the colored agglomerated particles. In one embodiment, the pigment is added at a loading rate of 5 wt % to 40 wt % based on a dry mass of the colored agglomerated particles. In one embodiment, the pigment is added at a loading rate of 10 wt % to 40 wt % based on a dry mass of the colored agglomerated particles. In one embodiment, the pigment is added at a loading rate of 20 wt % to 40 wt % based on a dry mass of the colored agglomerated particles. In one embodiment, the pigment is added at a loading rate of 30 wt % to 40 wt % based on a dry mass of the colored agglomerated particles. In one embodiment, the pigment is added at a loading rate of 1 wt % to 30 wt % based on a dry mass of the colored agglomerated particles. In one embodiment, the pigment is added at a loading rate of 5 wt % to 30 wt % based on a dry mass of the colored agglomerated particles. In one embodiment, the pigment is added at a loading rate of 10 wt % to 30 wt % based on a dry mass of the colored agglomerated particles. In one embodiment, the pigment is added at a loading rate of 20 wt % to 30 wt % based on a dry mass of the colored agglomerated particles. In one embodiment, the pigment is added at a loading rate of 1 wt % to 20 wt % based on a dry mass of the colored agglomerated particles. In one embodiment, the pigment is added at a loading rate of 5 wt % to 20 wt % based on a dry mass of the colored agglomerated particles. In one embodiment, the pigment is added at a loading rate of 10 wt % to 20 wt % based on a dry mass of the colored agglomerated particles. In one embodiment, the pigment is added at a loading rate of 1 wt % to 10 wt % based on a dry mass of the colored agglomerated particles. In one embodiment, the pigment is added at a loading rate of 5 wt % to 10 wt % based on a dry mass of the colored agglomerated particles. In one embodiment, the pigment is added at a loading rate of 1 wt % to 5 wt % based on a dry mass of the colored agglomerated particles.

In one embodiment, the colored rock fines, the colored mineral fines, or a combination of the colored rock fines and the colored mineral fines (e.g., waste pigment material) is added at a loading rate of 1 wt % to 100 wt % based on a dry mass of the colored agglomerated particles. In one embodiment, the colored rock fines, the colored mineral fines, or a combination of the colored rock fines and the colored mineral fines is added at a loading rate of 5 wt % to 100 wt % based on a dry mass of the colored agglomerated particles. In one embodiment, the colored rock fines, the colored mineral fines, or a combination of the colored rock fines and the colored mineral fines is added at a loading rate of 10 wt % to 100 wt % based on a dry mass of the colored agglomerated particles. In one embodiment, the colored rock fines, the colored mineral fines, or a combination of the colored rock fines and the colored mineral fines is added at a loading rate of 20 wt % to 100 wt % based on a dry mass of the colored agglomerated particles. In one embodiment, the colored rock fines, the colored mineral fines, or a combination of the colored rock fines and the colored mineral fines is added at a loading rate of 25 wt % to 100 wt % based on a dry mass of the colored agglomerated particles. In one embodiment, the colored rock fines, the colored mineral fines, or a combination of the colored rock fines and the colored mineral fines is added at a loading rate of 30 wt % to 100 wt % based on a dry mass of the colored agglomerated particles. In one embodiment, the colored rock fines, the colored mineral fines, or a combination of the colored rock fines and the colored mineral fines is added at a loading rate of 40 wt % to 100 wt % based on a dry mass of the colored agglomerated particles. In one embodiment, the colored rock fines, the colored mineral fines, or a combination of the colored rock fines and the colored mineral fines is added at a loading rate of 50 wt % to 100 wt % based on a dry mass of the colored agglomerated particles. In one embodiment, the colored rock fines, the colored mineral fines, or a combination of the colored rock fines and the colored mineral fines is added at a loading rate of 60 wt % to 100 wt % based on a dry mass of the colored agglomerated particles. In one embodiment, the colored rock fines, the colored mineral fines, or a combination of the colored rock fines and the colored mineral fines is added at a loading rate of 70 wt % to 100 wt % based on a dry mass of the colored agglomerated particles. In one embodiment, the colored rock fines, the colored mineral fines, or a combination of the colored rock fines and the colored mineral fines is added at a loading rate of 80 wt % to 100 wt % based on a dry mass of the colored agglomerated particles. In one embodiment, the colored rock fines, the colored mineral fines, or a combination of the colored rock fines and the colored mineral fines is added at a loading rate of 90 wt % to 100 wt % based on a dry mass of the colored agglomerated particles. In one embodiment, the colored rock fines, the colored mineral fines, or a combination of the colored rock fines and the colored mineral fines is added at a loading rate of 95 wt % to 100 wt % based on a dry mass of the colored agglomerated particles.

In one embodiment, the colored rock fines, the colored mineral fines, or a combination of the colored rock fines and the colored mineral fines is added at a loading rate of 1 wt % to 95 wt % based on a dry mass of the colored agglomerated particles. In one embodiment, the colored rock fines, the colored mineral fines, or a combination of the colored rock fines and the colored mineral fines is added at a loading rate of 5 wt % to 95 wt % based on a dry mass of the colored agglomerated particles. In one embodiment, the colored rock fines, the colored mineral fines, or a combination of the colored rock fines and the colored mineral fines is added at a loading rate of 10 wt % to 95 wt % based on a dry mass of the colored agglomerated particles. In one embodiment, the colored rock fines, the colored mineral fines, or a combination of the colored rock fines and the colored mineral fines is added at a loading rate of 20 wt % to 95 wt % based on a dry mass of the colored agglomerated particles. In one embodiment, the colored rock fines, the colored mineral fines, or a combination of the colored rock fines and the colored mineral fines is added at a loading rate of 25 wt % to 95 wt % based on a dry mass of the colored agglomerated particles. In one embodiment, the colored rock fines, the colored mineral fines, or a combination of the colored rock fines and the colored mineral fines is added at a loading rate of 30 wt % to 95 wt % based on a dry mass of the colored agglomerated particles. In one embodiment, the colored rock fines, the colored mineral fines, or a combination of the colored rock fines and the colored mineral fines is added at a loading rate of 40 wt % to 95 wt % based on a dry mass of the colored agglomerated particles. In one embodiment, the colored rock fines, the colored mineral fines, or a combination of the colored rock fines and the colored mineral fines is added at a loading rate of 50 wt % to 95 wt % based on a dry mass of the colored agglomerated particles. In one embodiment, the colored rock fines, the colored mineral fines, or a combination of the colored rock fines and the colored mineral fines is added at a loading rate of 60 wt % to 95 wt % based on a dry mass of the colored agglomerated particles. In one embodiment, the colored rock fines, the colored mineral fines, or a combination of the colored rock fines and the colored mineral fines is added at a loading rate of 70 wt % to 95 wt % based on a dry mass of the colored agglomerated particles. In one embodiment, the colored rock fines, the colored mineral fines, or a combination of the colored rock fines and the colored mineral fines is added at a loading rate of 80 wt % to 95 wt % based on a dry mass of the colored agglomerated particles. In one embodiment, the colored rock fines, the colored mineral fines, or a combination of the colored rock fines and the colored mineral fines is added at a loading rate of 90 wt % to 95 wt % based on a dry mass of the colored agglomerated particles.

In one embodiment, the colored rock fines, the colored mineral fines, or a combination of the colored rock fines and the colored mineral fines is added at a loading rate of 1 wt % to 90 wt % based on a dry mass of the colored agglomerated particles. In one embodiment, the colored rock fines, the colored mineral fines, or a combination of the colored rock fines and the colored mineral fines is added at a loading rate of 5 wt % to 90 wt % based on a dry mass of the colored agglomerated particles. In one embodiment, the colored rock fines, the colored mineral fines, or a combination of the colored rock fines and the colored mineral fines is added at a loading rate of 10 wt % to 90 wt % based on a dry mass of the colored agglomerated particles. In one embodiment, the colored rock fines, the colored mineral fines, or a combination of the colored rock fines and the colored mineral fines is added at a loading rate of 20 wt % to 90 wt % based on a dry mass of the colored agglomerated particles. In one embodiment, t the colored rock fines, the colored mineral fines, or a combination of the colored rock fines and the colored mineral fines is added at a loading rate of 25 wt % to 90 wt % based on a dry mass of the colored agglomerated particles. In one embodiment, the colored rock fines, the colored mineral fines, or a combination of the colored rock fines and the colored mineral fines is added at a loading rate of 30 wt % to 90 wt % based on a dry mass of the colored agglomerated particles. In one embodiment, the colored rock fines, the colored mineral fines, or a combination of the colored rock fines and the colored mineral fines is added at a loading rate of 40 wt % to 90 wt % based on a dry mass of the colored agglomerated particles. In one embodiment, the colored rock fines, the colored mineral fines, or a combination of the colored rock fines and the colored mineral fines is added at a loading rate of 50 wt % to 90 wt % based on a dry mass of the colored agglomerated particles. In one embodiment, the colored rock fines, the colored mineral fines, or a combination of the colored rock fines and the colored mineral fines is added at a loading rate of 60 wt % to 90 wt % based on a dry mass of the colored agglomerated particles. In one embodiment, the colored rock fines, the colored mineral fines, or a combination of the colored rock fines and the colored mineral fines is added at a loading rate of 70 wt % to 90 wt % based on a dry mass of the colored agglomerated particles. In one embodiment, the colored rock fines, the colored mineral fines, or a combination of the colored rock fines and the colored mineral fines is added at a loading rate of 80 wt % to 90 wt % based on a dry mass of the colored agglomerated particles.

In one embodiment, the colored rock fines, the colored mineral fines, or a combination of the colored rock fines and the colored mineral fines is added at a loading rate of 1 wt % to 80 wt % based on a dry mass of the colored agglomerated particles. In one embodiment, the colored rock fines, the colored mineral fines, or a combination of the colored rock fines and the colored mineral fines is added at a loading rate of 5 wt % to 80 wt % based on a dry mass of the colored agglomerated particles. In one embodiment, the colored rock fines, the colored mineral fines, or a combination of the colored rock fines and the colored mineral fines is added at a loading rate of 10 wt % to 80 wt % based on a dry mass of the colored agglomerated particles. In one embodiment, the colored rock fines, the colored mineral fines, or a combination of the colored rock fines and the colored mineral fines is added at a loading rate of 20 wt % to 80 wt % based on a dry mass of the colored agglomerated particles. In one embodiment, the colored rock fines, the colored mineral fines, or a combination of the colored rock fines and the colored mineral fines is added at a loading rate of 25 wt % to 80 wt % based on a dry mass of the colored agglomerated particles. In one embodiment, the colored rock fines, the colored mineral fines, or a combination of the colored rock fines and the colored mineral fines is added at a loading rate of 30 wt % to 80 wt % based on a dry mass of the colored agglomerated particles. In one embodiment, the colored rock fines, the colored mineral fines, or a combination of the colored rock fines and the colored mineral fines is added at a loading rate of 40 wt % to 80 wt % based on a dry mass of the colored agglomerated particles. In one embodiment, the colored rock fines, the colored mineral fines, or a combination of the colored rock fines and the colored mineral fines is added at a loading rate of 50 wt % to 80 wt % based on a dry mass of the colored agglomerated particles. In one embodiment, the colored rock fines, the colored mineral fines, or a combination of the colored rock fines and the colored mineral fines is added at a loading rate of 60 wt % to 80 wt % based on a dry mass of the colored agglomerated particles. In one embodiment, the colored rock fines, the colored mineral fines, or a combination of the colored rock fines and the colored mineral fines is added at a loading rate of 70 wt % to 80 wt % based on a dry mass of the colored agglomerated particles. In one embodiment, the colored rock fines, the colored mineral fines, or a combination of the colored rock fines and the colored mineral fines is added at a loading rate of 1 wt % to 70 wt % based on a dry mass of the colored agglomerated particles. In one embodiment, the colored rock fines, the colored mineral fines, or a combination of the colored rock fines and the colored mineral fines is added at a loading rate of 5 wt % to 70 wt % based on a dry mass of the colored agglomerated particles. In one embodiment, the colored rock fines, the colored mineral fines, or a combination of the colored rock fines and the colored mineral fines is added at a loading rate of 10 wt % to 70 wt % based on a dry mass of the colored agglomerated particles. In one embodiment, the colored rock fines, the colored mineral fines, or a combination of the colored rock fines and the colored mineral fines is added at a loading rate of 20 wt % to 70 wt % based on a dry mass of the colored agglomerated particles. In one embodiment, the colored rock fines, the colored mineral fines, or a combination of the colored rock fines and the colored mineral fines is added at a loading rate of 25 wt % to 70 wt % based on a dry mass of the colored agglomerated particles. In one embodiment, the colored rock fines, the colored mineral fines, or a combination of the colored rock fines and the colored mineral fines is added at a loading rate of 30 wt % to 70 wt % based on a dry mass of the colored agglomerated particles. In one embodiment, the colored rock fines, the colored mineral fines, or a combination of the colored rock fines and the colored mineral fines is added at a loading rate of 40 wt % to 70 wt % based on a dry mass of the colored agglomerated particles. In one embodiment, the colored rock fines, the colored mineral fines, or a combination of the colored rock fines and the colored mineral fines is added at a loading rate of 50 wt % to 70 wt % based on a dry mass of the colored agglomerated particles. In one embodiment, the colored rock fines, the colored mineral fines, or a combination of the colored rock fines and the colored mineral fines is added at a loading rate of 60 wt % to 70 wt % based on a dry mass of the colored agglomerated particles. In one embodiment, the colored rock fines, the colored mineral fines, or a combination of the colored rock fines and the colored mineral fines is added at a loading rate of 1 wt % to 60 wt % based on a dry mass of the colored agglomerated particles. In one embodiment, the colored rock fines, the colored mineral fines, or a combination of the colored rock fines and the colored mineral fines is added at a loading rate of 5 wt % to 60 wt % based on a dry mass of the colored agglomerated particles. In one embodiment, the colored rock fines, the colored mineral fines, or a combination of the colored rock fines and the colored mineral fines is added at a loading rate of 10 wt % to 60 wt % based on a dry mass of the colored agglomerated particles. In one embodiment, the colored rock fines, the colored mineral fines, or a combination of the colored rock fines and the colored mineral fines is added at a loading rate of 20 wt % to 60 wt % based on a dry mass of the colored agglomerated particles. In one embodiment, the colored rock fines, the colored mineral fines, or a combination of the colored rock fines and the colored mineral fines is added at a loading rate of 25 wt % to 60 wt % based on a dry mass of the colored agglomerated particles. In one embodiment, the colored rock fines, the colored mineral fines, or a combination of the colored rock fines and the colored mineral fines is added at a loading rate of 30 wt % to 60 wt % based on a dry mass of the colored agglomerated particles. In one embodiment, the colored rock fines, the colored mineral fines, or a combination of the colored rock fines and the colored mineral fines is added at a loading rate of 40 wt % to 60 wt % based on a dry mass of the colored agglomerated particles. In one embodiment, the colored rock fines, the colored mineral fines, or a combination of the colored rock fines and the colored mineral fines is added at a loading rate of 50 wt % to 60 wt % based on a dry mass of the colored agglomerated particles. In one embodiment, the colored rock fines, the colored mineral fines, or a combination of the colored rock fines and the colored mineral fines is added at a loading rate of 1 wt % to 50 wt % based on a dry mass of the colored agglomerated particles. In one embodiment, the colored rock fines, the colored mineral fines, or a combination of the colored rock fines and the colored mineral fines is added at a loading rate of 5 wt % to 50 wt % based on a dry mass of the colored agglomerated particles. In one embodiment, the colored rock fines, the colored mineral fines, or a combination of the colored rock fines and the colored mineral fines is added at a loading rate of 10 wt % to 50 wt % based on a dry mass of the colored agglomerated particles. In one embodiment, the colored rock fines, the colored mineral fines, or a combination of the colored rock fines and the colored mineral fines is added at a loading rate of 20 wt % to 50 wt % based on a dry mass of the colored agglomerated particles. In one embodiment, the colored rock fines, the colored mineral fines, or a combination of the colored rock fines and the colored mineral fines is added at a loading rate of 25 wt % to 50 wt % based on a dry mass of the colored agglomerated particles. In one embodiment, the colored rock fines, the colored mineral fines, or a combination of the colored rock fines and the colored mineral fines is added at a loading rate of 30 wt % to 50 wt % based on a dry mass of the colored agglomerated particles. In one embodiment, the colored rock fines, the colored mineral fines, or a combination of the colored rock fines and the colored mineral fines is added at a loading rate of 40 wt % to 50 wt % based on a dry mass of the colored agglomerated particles.

In one embodiment, the colored rock fines, the colored mineral fines, or a combination of the colored rock fines and the colored mineral fines is added at a loading rate of 1 wt % to 40 wt % based on a dry mass of the colored agglomerated particles. In one embodiment, the colored rock fines, the colored mineral fines, or a combination of the colored rock fines and the colored mineral fines is added at a loading rate of 5 wt % to 40 wt % based on a dry mass of the colored agglomerated particles. In one embodiment, the colored rock fines, the colored mineral fines, or a combination of the colored rock fines and the colored mineral fines is added at a loading rate of 10 wt % to 40 wt % based on a dry mass of the colored agglomerated particles. In one embodiment, the colored rock fines, the colored mineral fines, or a combination of the colored rock fines and the colored mineral fines is added at a loading rate of 20 wt % to 40 wt % based on a dry mass of the colored agglomerated particles. In one embodiment, the colored rock fines, the colored mineral fines, or a combination of the colored rock fines and the colored mineral fines is added at a loading rate of 25 wt % to 40 wt % based on a dry mass of the colored agglomerated particles. In one embodiment, the colored rock fines, the colored mineral fines, or a combination of the colored rock fines and the colored mineral fines is added at a loading rate of 30 wt % to 40 wt % based on a dry mass of the colored agglomerated particles. In one embodiment, the colored rock fines, the colored mineral fines, or a combination of the colored rock fines and the colored mineral fines is added at a loading rate of 1 wt % to 30 wt % based on a dry mass of the colored agglomerated particles. In one embodiment, the colored rock fines, the colored mineral fines, or a combination of the colored rock fines and the colored mineral fines is added at a loading rate of 5 wt % to 30 wt % based on a dry mass of the colored agglomerated particles. In one embodiment, the colored rock fines, the colored mineral fines, or a combination of the colored rock fines and the colored mineral fines is added at a loading rate of 10 wt % to 30 wt % based on a dry mass of the colored agglomerated particles. In one embodiment, the colored rock fines, the colored mineral fines, or a combination of the colored rock fines and the colored mineral fines is added at a loading rate of 20 wt % to 30 wt % based on a dry mass of the colored agglomerated particles. In one embodiment, the colored rock fines, the colored mineral fines, or a combination of the colored rock fines and the colored mineral fines is added at a loading rate of 25 wt % to 30 wt % based on a dry mass of the colored agglomerated particles. In one embodiment, the colored rock fines, the colored mineral fines, or a combination of the colored rock fines and the colored mineral fines is added at a loading rate of 1 wt % to 25 wt % based on a dry mass of the colored agglomerated particles. In one embodiment, the colored rock fines, the colored mineral fines, or a combination of the colored rock fines and the colored mineral fines is added at a loading rate of 5 wt % to 25 wt % based on a dry mass of the colored agglomerated particles. In one embodiment, the colored rock fines, the colored mineral fines, or a combination of the colored rock fines and the colored mineral fines is added at a loading rate of 10 wt % to 25 wt % based on a dry mass of the colored agglomerated particles. In one embodiment, the colored rock fines, the colored mineral fines, or a combination of the colored rock fines and the colored mineral fines is added at a loading rate of 20 wt % to 25 wt % based on a dry mass of the colored agglomerated particles. In one embodiment, the colored rock fines, the colored mineral fines, or a combination of the colored rock fines and the colored mineral fines is added at a loading rate of 1 wt % to 20 wt % based on a dry mass of the colored agglomerated particles. In one embodiment, the colored rock fines, the colored mineral fines, or a combination of the colored rock fines and the colored mineral fines is added at a loading rate of 5 wt % to 20 wt % based on a dry mass of the colored agglomerated particles. In one embodiment, the colored rock fines, the colored mineral fines, or a combination of the colored rock fines and the colored mineral fines is added at a loading rate of 10 wt % to 20 wt % based on a dry mass of the colored agglomerated particles. In one embodiment, the colored rock fines, the colored mineral fines, or a combination of the colored rock fines and the colored mineral fines is added at a loading rate of 1 wt % to 10 wt % based on a dry mass of the colored agglomerated particles. In one embodiment, the colored rock fines, the colored mineral fines, or a combination of the colored rock fines and the colored mineral fines is added at a loading rate of 5 wt % to 10 wt % based on a dry mass of the colored agglomerated particles. In one embodiment, the colored rock fines, the colored mineral fines, or a combination of the colored rock fines and the colored mineral fines is added at a loading rate of 1 wt % to 5 wt % based on a dry mass of the colored agglomerated particles.

In one embodiment, the at least one of rock fines, mineral fines, or a combination thereof is added in an amount of 5 wt % to 95 wt % with respect to a total dry weight of the colored agglomerated particles. In one embodiment, the at least one of rock fines, mineral fines, or a combination thereof is added in an amount of 10 wt % to 95 wt % with respect to a total dry weight of the colored agglomerated particles. In one embodiment, the at least one of rock fines, mineral fines, or a combination thereof is added in an amount of 20 wt % to 95 wt % with respect to a total dry weight of the colored agglomerated particles. In one embodiment, the at least one of rock fines, mineral fines, or a combination thereof is added in an amount of 30 wt % to 95 wt % with respect to a total dry weight of the colored agglomerated particles. In one embodiment, the at least one of rock fines, mineral fines, or a combination thereof is added in an amount of 40 wt % to 95 wt % with respect to a total dry weight of the colored agglomerated particles. In one embodiment, the at least one of rock fines, mineral fines, or a combination thereof is added in an amount of 50 wt % to 95 wt % with respect to a total dry weight of the colored agglomerated particles. In one embodiment, the at least one of rock fines, mineral fines, or a combination thereof is added in an amount of 60 wt % to 95 wt % with respect to a total dry weight of the colored agglomerated particles. In one embodiment, the at least one of rock fines, mineral fines, or a combination thereof is added in an amount of 70 wt % to 95 wt % with respect to a total dry weight of the colored agglomerated particles. In one embodiment, the at least one of rock fines, mineral fines, or a combination thereof is added in an amount of 80 wt % to 95 wt % with respect to a total dry weight of the colored agglomerated particles. In one embodiment, the at least one of rock fines, mineral fines, or a combination thereof is added in an amount of 90 wt % to 95 wt % with respect to a total dry weight of the colored agglomerated particles.

In one embodiment, the at least one of rock fines, mineral fines, or a combination thereof is added in an amount of 5 wt % to 90 wt % with respect to a total dry weight of the colored agglomerated particles. In one embodiment, the at least one of rock fines, mineral fines, or a combination thereof is added in an amount of 10 wt % to 90 wt % with respect to a total dry weight of the colored agglomerated particles. In one embodiment, the at least one of rock fines, mineral fines, or a combination thereof is added in an amount of 20 wt % to 90 wt % with respect to a total dry weight of the colored agglomerated particles. In one embodiment, the at least one of rock fines, mineral fines, or a combination thereof is added in an amount of 30 wt % to 90 wt % with respect to a total dry weight of the colored agglomerated particles. In one embodiment, the at least one of rock fines, mineral fines, or a combination thereof is added in an amount of 40 wt % to 90 wt % with respect to a total dry weight of the colored agglomerated particles. In one embodiment, the at least one of rock fines, mineral fines, or a combination thereof is added in an amount of 50 wt % to 90 wt % with respect to a total dry weight of the colored agglomerated particles. In one embodiment, the at least one of rock fines, mineral fines, or a combination thereof is added in an amount of 60 wt % to 90 wt % with respect to a total dry weight of the colored agglomerated particles. In one embodiment, the at least one of rock fines, mineral fines, or a combination thereof is added in an amount of 70 wt % to 90 wt % with respect to a total dry weight of the colored agglomerated particles. In one embodiment, the at least one of rock fines, mineral fines, or a combination thereof is added in an amount of 80 wt % to 90 wt % with respect to a total dry weight of the colored agglomerated particles.

In one embodiment, the at least one of rock fines, mineral fines, or a combination thereof is added in an amount of 5 wt % to 80 wt % with respect to a total dry weight of the colored agglomerated particles. In one embodiment, the at least one of rock fines, mineral fines, or a combination thereof is added in an amount of 10 wt % to 80 wt % with respect to a total dry weight of the colored agglomerated particles. In one embodiment, the at least one of rock fines, mineral fines, or a combination thereof is added in an amount of 20 wt % to 80 wt % with respect to a total dry weight of the colored agglomerated particles. In one embodiment, the at least one of rock fines, mineral fines, or a combination thereof is added in an amount of 30 wt % to 80 wt % with respect to a total dry weight of the colored agglomerated particles. In one embodiment, the at least one of rock fines, mineral fines, or a combination thereof is added in an amount of 40 wt % to 80 wt % with respect to a total dry weight of the colored agglomerated particles. In one embodiment, the at least one of rock fines, mineral fines, or a combination thereof is added in an amount of 50 wt % to 80 wt % with respect to a total dry weight of the colored agglomerated particles. In one embodiment, the at least one of rock fines, mineral fines, or a combination thereof is added in an amount of 60 wt % to 80 wt % with respect to a total dry weight of the colored agglomerated particles. In one embodiment, the at least one of rock fines, mineral fines, or a combination thereof is added in an amount of 70 wt % to 80 wt % with respect to a total dry weight of the colored agglomerated particles. In one embodiment, the at least one of rock fines, mineral fines, or a combination thereof is added in an amount of 5 wt % to 70 wt % with respect to a total dry weight of the colored agglomerated particles. In one embodiment, the at least one of rock fines, mineral fines, or a combination thereof is added in an amount of 10 wt % to 70 wt % with respect to a total dry weight of the colored agglomerated particles. In one embodiment, the at least one of rock fines, mineral fines, or a combination thereof is added in an amount of 20 wt % to 70 wt % with respect to a total dry weight of the colored agglomerated particles. In one embodiment, the at least one of rock fines, mineral fines, or a combination thereof is added in an amount of 30 wt % to 70 wt % with respect to a total dry weight of the colored agglomerated particles. In one embodiment, the at least one of rock fines, mineral fines, or a combination thereof is added in an amount of 40 wt % to 70 wt % with respect to a total dry weight of the colored agglomerated particles. In one embodiment, the at least one of rock fines, mineral fines, or a combination thereof is added in an amount of 50 wt % to 70 wt % with respect to a total dry weight of the colored agglomerated particles. In one embodiment, the at least one of rock fines, mineral fines, or a combination thereof is added in an amount of 60 wt % to 70 wt % with respect to a total dry weight of the colored agglomerated particles. In one embodiment, the at least one of rock fines, mineral fines, or a combination thereof is added in an amount of 5 wt % to 60 wt % with respect to a total dry weight of the colored agglomerated particles. In one embodiment, the at least one of rock fines, mineral fines, or a combination thereof is added in an amount of 10 wt % to 60 wt % with respect to a total dry weight of the colored agglomerated particles. In one embodiment, the at least one of rock fines, mineral fines, or a combination thereof is added in an amount of 20 wt % to 60 wt % with respect to a total dry weight of the colored agglomerated particles. In one embodiment, the at least one of rock fines, mineral fines, or a combination thereof is added in an amount of 30 wt % to 60 wt % with respect to a total dry weight of the colored agglomerated particles. In one embodiment, the at least one of rock fines, mineral fines, or a combination thereof is added in an amount of 40 wt % to 60 wt % with respect to a total dry weight of the colored agglomerated particles. In one embodiment, the at least one of rock fines, mineral fines, or a combination thereof is added in an amount of 50 wt % to 60 wt % with respect to a total dry weight of the colored agglomerated particles.

In one embodiment, the at least one of rock fines, mineral fines, or a combination thereof is added in an amount of 5 wt % to 50 wt % with respect to a total dry weight of the colored agglomerated particles. In one embodiment, the at least one of rock fines, mineral fines, or a combination thereof is added in an amount of 10 wt % to 50 wt % with respect to a total dry weight of the colored agglomerated particles. In one embodiment, the at least one of rock fines, mineral fines, or a combination thereof is added in an amount of 20 wt % to 50 wt % with respect to a total dry weight of the colored agglomerated particles. In one embodiment, the at least one of rock fines, mineral fines, or a combination thereof is added in an amount of 30 wt % to 50 wt % with respect to a total dry weight of the colored agglomerated particles. In one embodiment, the at least one of rock fines, mineral fines, or a combination thereof is added in an amount of 40 wt % to 50 wt % with respect to a total dry weight of the colored agglomerated particles. In one embodiment, the at least one of rock fines, mineral fines, or a combination thereof is added in an amount of 5 wt % to 40 wt % with respect to a total dry weight of the colored agglomerated particles. In one embodiment, the at least one of rock fines, mineral fines, or a combination thereof is added in an amount of 10 wt % to 40 wt % with respect to a total dry weight of the colored agglomerated particles. In one embodiment, the at least one of rock fines, mineral fines, or a combination thereof is added in an amount of 20 wt % to 40 wt % with respect to a total dry weight of the colored agglomerated particles. In one embodiment, the at least one of rock fines, mineral fines, or a combination thereof is added in an amount of 30 wt % to 40 wt % with respect to a total dry weight of the colored agglomerated particles. In one embodiment, the at least one of rock fines, mineral fines, or a combination thereof is added in an amount of 5 wt % to 30 wt % with respect to a total dry weight of the colored agglomerated particles. In one embodiment, the at least one of rock fines, mineral fines, or a combination thereof is added in an amount of 10 wt % to 30 wt % with respect to a total dry weight of the colored agglomerated particles. In one embodiment, the at least one of rock fines, mineral fines, or a combination thereof is added in an amount of 20 wt % to 30 wt % with respect to a total dry weight of the colored agglomerated particles. In one embodiment, the at least one of rock fines, mineral fines, or a combination thereof is added in an amount of 5 wt % to 20 wt % with respect to a total dry weight of the colored agglomerated particles. In one embodiment, the at least one of rock fines, mineral fines, or a combination thereof is added in an amount of 10 wt % to 20 wt % with respect to a total dry weight of the colored agglomerated particles. In one embodiment, the at least one of rock fines, mineral fines, or a combination thereof is added in an amount of 5 wt % to 10 wt % with respect to a total dry weight of the colored agglomerated particles.

A non-limiting example of the binder includes sodium silicate. According to one embodiment, the binder is at least one of sodium silicate, gypsum, or a combination thereof.

In an embodiment, the content of the binder in the colored agglomerated particles is at least about 1 wt %, at least about 2 wt %, at least about 3 wt %, at least about 5 wt %, at least about 6 wt %, at least about 10 wt %, at least about 12 wt %, at least about 13 wt %, at least about 14 wt %, or at least about 15 wt %.

In an embodiment, the content of the binder in the colored agglomerated particles is from about 1 wt % to about 15 wt %. In an embodiment, the content of the binder in the colored agglomerated particles is from about 2 wt % to about 15 wt %. In an embodiment, the content of the binder in the colored agglomerated particles is from about 3 wt % to about 15 wt %. In an embodiment, the content of the binder in the colored agglomerated particles is from about 4 wt % to about 15 wt %. In an embodiment, the content of the binder in the colored agglomerated particles is from about 5 wt % to about 15 wt %. In an embodiment, the content of the binder in the colored agglomerated particles is from about 6 wt % to about 15 wt %. In an embodiment, the content of the binder in the colored agglomerated particles is from about 7 wt % to about 15 wt %. In an embodiment, the content of the binder in the colored agglomerated particles is from about 8 wt % to about 15 wt %. In an embodiment, the content of the binder in the colored agglomerated particles is from about 9 wt % to about 15 wt %. In an embodiment, the content of the binder in the colored agglomerated particles is from about 10 wt % to about 15 wt %. In an embodiment, the content of the binder in the colored agglomerated particles is from about 11 wt % to about 15 wt %. In an embodiment, the content of the binder in the colored agglomerated particles is from about 12 wt % to about 15 wt %. In an embodiment, the content of the binder in the colored agglomerated particles is from about 13 wt % to about 15 wt %. In an embodiment, the content of the binder in the colored agglomerated particles is from about 14 wt % to about 15 wt %.

In an embodiment, the content of the binder in the colored agglomerated particles is from about 1 wt % to about 14 wt %. In an embodiment, the content of the binder in the colored agglomerated particles is from about 2 wt % to about 14 wt %. In an embodiment, the content of the binder in the colored agglomerated particles is from about 3 wt % to about 14 wt %. In an embodiment, the content of the binder in the colored agglomerated particles is from about 4 wt % to about 14 wt %. In an embodiment, the content of the binder in the colored agglomerated particles is from about 5 wt % to about 14 wt %. In an embodiment, the content of the binder in the colored agglomerated particles is from about 6 wt % to about 14 wt %. In an embodiment, the content of the binder in the colored agglomerated particles is from about 7 wt % to about 14 wt %. In an embodiment, the content of the binder in the colored agglomerated particles is from about 8 wt % to about 14 wt %. In an embodiment, the content of the binder in the colored agglomerated particles is from about 9 wt % to about 14 wt %. In an embodiment, the content of the binder in the colored agglomerated particles is from about 10 wt % to about 14 wt %. In an embodiment, the content of the binder in the colored agglomerated particles is from about 11 wt % to about 14 wt %. In an embodiment, the content of the binder in the colored agglomerated particles is from about 12 wt % to about 14 wt %. In an embodiment, the content of the binder in the colored agglomerated particles is from about 13 wt % to about 14 wt %.

In an embodiment, the content of the binder in the colored agglomerated particles is from about 1 wt % to about 13 wt %. In an embodiment, the content of the binder in the colored agglomerated particles is from about 2 wt % to about 13 wt %. In an embodiment, the content of the binder in the colored agglomerated particles is from about 3 wt % to about 13 wt %. In an embodiment, the content of the binder in the colored agglomerated particles is from about 4 wt % to about 13 wt %. In an embodiment, the content of the binder in the colored agglomerated particles is from about 5 wt % to about 13 wt %. In an embodiment, the content of the binder in the colored agglomerated particles is from about 6 wt % to about 13 wt %. In an embodiment, the content of the binder in the colored agglomerated particles is from about 7 wt % to about 13 wt %. In an embodiment, the content of the binder in the colored agglomerated particles is from about 8 wt % to about 13 wt %. In an embodiment, the content of the binder in the colored agglomerated particles is from about 9 wt % to about 13 wt %. In an embodiment, the content of the binder in the colored agglomerated particles is from about 10 wt % to about 13 wt %. In an embodiment, the content of the binder in the colored agglomerated particles is from about 11 wt % to about 13 wt %. In an embodiment, the content of the binder in the colored agglomerated particles is from about 12 wt % to about 13 wt %.

In an embodiment, the content of the binder in the colored agglomerated particles is from about 1 wt % to about 12 wt %. In an embodiment, the content of the binder in the colored agglomerated particles is from about 2 wt % to about 12 wt %. In an embodiment, the content of the binder in the colored agglomerated particles is from about 3 wt % to about 12 wt %. In an embodiment, the content of the binder in the colored agglomerated particles is from about 4 wt % to about 12 wt %. In an embodiment, the content of the binder in the colored agglomerated particles is from about 5 wt % to about 12 wt %. In an embodiment, the content of the binder in the colored agglomerated particles is from about 6 wt % to about 12 wt %. In an embodiment, the content of the binder in the colored agglomerated particles is from about 7 wt % to about 12 wt %. In an embodiment, the content of the binder in the colored agglomerated particles is from about 8 wt % to about 12 wt %. In an embodiment, the content of the binder in the colored agglomerated particles is from about 9 wt % to about 12 wt %. In an embodiment, the content of the binder in the colored agglomerated particles is from about 10 wt % to about 12 wt %. In an embodiment, the content of the binder in the colored agglomerated particles is from about 11 wt % to about 12 wt %.

In an embodiment, the content of the binder in the colored agglomerated particles is about 12 wt %. In an embodiment, the content of the binder in the colored agglomerated particles is about 13 wt %. In an embodiment, the content of the binder in the colored agglomerated particles is about 13.5 wt %. In an embodiment, the content of the binder in the colored agglomerated particles is about 14 wt %.

In embodiments, the colored agglomerated particles comprise the content of the pigment of any of the embodiments detailed herein, the content of the binder of any of the embodiments detailed herein, with the rock and/or mineral fragments (i.e., uncolored rock and/or mineral fragments) forming the remainder.

In embodiments, the colored agglomerated particles comprise the content of the colored rock and/or colored mineral fines (e.g., waste pigment material) of any of the embodiments detailed herein, the content of the binder of any of the embodiments detailed herein, with the rock and/or mineral fragments (i.e., uncolored rock and/or mineral fragments) forming the remainder.

In embodiments, the colored agglomerated particles comprise the content of the pigment of any of the embodiments detailed herein, the content the colored rock and/or colored mineral fines of any of the embodiments detailed herein, the content of the binder of any of the embodiments detailed herein, with the rock and/or mineral fragments (i.e., uncolored rock and/or mineral fragments) forming the remainder.

In one embodiment, the colored rock and/or colored mineral fines (e.g., waste pigment material) have an average particle size that is larger than that of a virgin pigment. In one embodiment, the colored rock and/or colored mineral fines (e.g., waste pigment material) have an average particle size of 5 to 100 μm. In one embodiment, the colored rock and/or colored mineral fines (e.g., waste pigment material) have an average particle size of 10 to 100 μm. In one embodiment, the colored rock and/or colored mineral fines (e.g., waste pigment material) have an average particle size of 20 to 100 μm. In one embodiment, the colored rock and/or colored mineral fines (e.g., waste pigment material) have an average particle size of 30 to 100 μm. In one embodiment, the colored rock and/or colored mineral fines (e.g., waste pigment material) have an average particle size of 40 to 100 μm. In one embodiment, the colored rock and/or colored mineral fines (e.g., waste pigment material) have an average particle size of 50 to 100 μm. In one embodiment, the colored rock and/or colored mineral fines (e.g., waste pigment material) have an average particle size of 60 to 100 μm. In one embodiment, the colored rock and/or colored mineral fines (e.g., waste pigment material) have an average particle size of 70 to 100 μm. In one embodiment, the colored rock and/or colored mineral fines (e.g., waste pigment material) have an average particle size of 80 to 100 μm. In one embodiment, the colored rock and/or colored mineral fines (e.g., waste pigment material) have an average particle size of 90 to 100 μm.

In one embodiment, the colored rock and/or colored mineral fines (e.g., waste pigment material) comprise at least one of (i) clay materials, (ii) rock fines, mineral fines, or a combination thereof, (iii) one or more pigments, (iv) silicates, or (v) a combination thereof.

In one embodiment, the colored rock and/or colored mineral fines (e.g., waste pigment material) comprise more than 1 wt % of at least one of sodium (Na), magnesium (Mg), aluminum (Al), or silicon (Si). In one embodiment, the colored rock and/or colored mineral fines (e.g., waste pigment material) comprise from 1 wt % to 10 wt % of at least one of sodium (Na), magnesium (Mg), aluminum (Al), or silicon (Si). In one embodiment, the colored rock and/or colored mineral fines (e.g., waste pigment material) comprise from 1 wt % to 5 wt % of at least one of sodium (Na), magnesium (Mg), aluminum (Al), or silicon (Si).

In one embodiment, the colored rock and/or colored mineral fines (e.g., waste pigment material) comprise more than 2 wt % of at least one of sodium (Na), aluminum (Al), or silicon (Si). In one embodiment, the colored rock and/or colored mineral fines (e.g., waste pigment material) comprise from 2 wt % to 10 wt % of at least one of sodium (Na), aluminum (Al), or silicon (Si). In one embodiment, the colored rock and/or colored mineral fines (e.g., waste pigment material) comprise from 2 wt % to 5 wt % of at least one of sodium (Na), aluminum (Al), or silicon (Si).

In one embodiment, the colored rock and/or colored mineral fines (e.g., waste pigment material) comprise 3 wt % or more of at least one of sodium (Na), aluminum (Al), or silicon (Si). In one embodiment, the colored rock and/or colored mineral fines (e.g., waste pigment material) comprise from 3 wt % to 10 wt % of at least one of sodium (Na), aluminum (Al), or silicon (Si). In one embodiment, the colored rock and/or colored mineral fines (e.g., waste pigment material) comprise from 3 wt % to 5 wt % of at least one of sodium (Na), aluminum (Al), or silicon (Si).

In one embodiment, the colored rock and/or colored mineral fines (e.g., waste pigment material) comprise more than 3 wt % of silicon (Si). In one embodiment, the colored rock and/or colored mineral fines (e.g., waste pigment material) comprise more than 5 wt % of silicon (Si). In one embodiment, the colored rock and/or colored mineral fines (e.g., waste pigment material) comprise 8 wt % or more of silicon (Si). In one embodiment, the colored rock and/or colored mineral fines (e.g., waste pigment material) comprise from 3 wt % to 10 wt % of silicon (Si). In one embodiment, the colored rock and/or colored mineral fines (e.g., waste pigment material) comprise from 5 wt % to 10 wt % of silicon (Si). In one embodiment, the colored rock and/or colored mineral fines (e.g., waste pigment material) comprise from 8 wt % to 10 wt % of silicon (Si).

In an embodiment, the colored agglomerated particles are applied to the buttlap of a roofing shingle.

In one embodiment, the colored agglomerated particles are unsintered.

In one embodiment, the colored agglomerated particles consist essentially of, or consist of, (a) the rock and/or mineral fragments, (b) the pigment, and (c) the binder.

In one embodiment, the colored agglomerated particles consist essentially of, or consist of, (a) the rock and/or mineral fragments, (b) the colored rock and/or colored mineral fines (e.g., waste pigment material), and (c) the binder.

In one embodiment, the colored agglomerated particles consist essentially of, or consist of, (a) the rock and/or mineral fragments, (b) the colored rock and/or colored mineral fines (e.g., waste pigment material), (c) the pigment, and (d) the binder.

In one embodiment, the colored agglomerated particles consist essentially of, or consist of, (a) the colored rock and/or colored mineral fines (e.g., waste pigment material) and (b) the binder.

### B. Colored Agglomerated Particles—Particle Size Distribution

In an embodiment, the colored agglomerated particles have a particle size distribution. In an embodiment, the particle size distribution is monomodal, bimodal or multimodal. That is, the colored agglomerated particles may have one, two or multiple modal sizes.

In an embodiment, the particle size distribution of the colored agglomerated particles applied, e.g., to the back surface of a roofing shingle comprises at least about 10 wt % particles of Tyler Mesh 20, at least about 20 wt % particles of Tyler Mesh 20, at least about 30 wt % particles of Tyler Mesh 20, or at least about 40 wt % particles of Tyler Mesh 20. In an embodiment, the particle size distribution of the colored agglomerated particles applied to the back surface of the shingle comprises at least about 5 wt % particles of Tyler Mesh 28, at least about 10 wt % particles of Tyler Mesh 28, at least about 20 wt % particles of Tyler Mesh 28, or at least about 30 wt % particles of Tyler Mesh 28. In an embodiment, the particle size distribution of the colored agglomerated particles applied to the back surface of the shingle comprises at least about 1 wt % particles of Tyler Mesh 35, at least about 5 wt % particles of Tyler Mesh 35, at least about 10 wt % particles of Tyler Mesh 35, or at least about 15 wt % particles of Tyler Mesh 35.

In another embodiment, the particle size distribution of the colored agglomerated particles applied, e.g., to the headlap of a roofing shingle comprises at least about 1 wt % particles of Tyler Mesh 20, at least about 2 wt % particles of Tyler Mesh 20, at least about 5 wt % particles of Tyler Mesh 20, at least about 10 wt % particles of Tyler Mesh 20, at least about 15 wt % particles of Tyler Mesh 20, at least about 20 wt % particles of Tyler Mesh 20, at least about 25 wt % particles of Tyler Mesh 20, at least at least about 30 wt % particles of Tyler Mesh 20, at least about 35 wt % particles of Tyler Mesh 20, or at least about 40 wt % particles of Tyler Mesh 20. In an embodiment, the particle size distribution of the colored agglomerated particles applied, e.g., to the headlap of a roofing shingle comprises at least about 1 wt % particles of Tyler Mesh 28, at least about 2 wt % particles of Tyler Mesh 28, at least about 5 wt % particles of Tyler Mesh 28, at least about 10 wt % particles of Tyler Mesh 28, at least about 15 wt % particles of Tyler Mesh 28, at least about 20 wt % particles of Tyler Mesh 28, at least about 25 wt % particles of Tyler Mesh 28, or at least at least about 30 wt % particles of Tyler Mesh 28. In an embodiment, the particle size distribution of the colored agglomerated particles applied, e.g., to the headlap of a roofing shingle comprises at least about 1 wt % particles of Tyler Mesh 35, at least about 2 wt % particles of Tyler Mesh 35, at least about 5 wt % particles of Tyler Mesh 35, at least about 10 wt % particles of Tyler Mesh 35, at least about 15 wt % particles of Tyler Mesh 35, or at least about 20 wt % particles of Tyler Mesh 35.

### C. Method of Making the Colored Agglomerated Particles

One embodiment of this invention pertains to a method of making colored agglomerated particles that can be applied to, e.g., roofing materials (e.g., roofing shingles). In an embodiment, rock and/or mineral fragments, at least one of a pigment, colored rock fines, colored mineral fines, or a combination thereof, and a binder (e.g., a liquid binder) are obtained. In one embodiment, the colored rock fines, the colored mineral fines, or a combination of the colored rock fines and the colored mineral fines are obtained from a waste stream from granule painting operations (i.e., the colored rock fines, the colored mineral fines, or a combination thereof comprise waste pigment material). In an embodiment, the rock and/or mineral fragments are combined (or mixed) with (i) the at least one of a pigment, colored rock fines, colored mineral fines, or a combination thereof (e.g., colored rock fines, colored mineral fines, or a combination thereof that can be obtained from, e.g., a waste stream from granule painting operations) and (ii) the liquid binder in, e.g., a pin mixer to produce colored agglomerated particles. In the pin mixer, pins or rods attached to a horizontal spinning shaft mix the components and produce colored agglomerated particles by the action of centrifugal force. In an embodiment, the loading rate of the pigment can be from 1 wt % to 10 wt % based on the total mass of the dry material at this step. In an embodiment, the loading rate of the colored rock fines, colored mineral fines, or a combination thereof can be from 1 wt % to 100 wt % based on the total mass of the dry material at this step. In an embodiment, the volume of the binder is typically between 1-5 wt % based on the total mass of the dry material at this step. In an embodiment, the colored agglomerated particles produced by the pin mixer are substantially spherical. In an embodiment, the colored agglomerated particles produced by the pin mixer may be dried and used directly. Colored agglomerated particles made by the pin mixer may be applied to the back surface or headlap of a roofing material (e.g., a roofing shingle).

In one embodiment, the mixing of (i) the at least one of a rock, a mineral, or a combination thereof, (ii) the at least one of a pigment, colored rock fines, colored mineral fines, or a combination thereof, and (iii) the binder is conducted to produce unsintered colored agglomerated particles.

In another embodiment, once the material is mixed in the pix mixer, the colored agglomerated particles produced by the pin mixer are combined with further liquid binder in a disc or pan pelletizer. The colored agglomerated particles produced by the pin mixer are fed into the disk/pan pelletizer where the binder is added to facilitate pelletization. According to one embodiment, the volume of the binder at this step is typically between 5-12 wt % based on the mass of the total dry mass. The colored agglomerated particle size is increased by the actions of tumble growth and centrifugal force. The colored agglomerated particle size may be controlled by varying the disc angle and speed of rotation, and by modulating the properties of the input particles and liquid binder. Once the desired colored agglomerated particle size is achieved, the colored agglomerated particles may be dried (e.g., in an oven or a fluidized bed dryer). The disc or pan pelletizer increases the colored agglomerated particle size and produces colored agglomerated particles that may be applied to the front surface buttlap of a roofing shingle. In an embodiment, the colored agglomerated particles are dried after leaving the pin mixer, or disc or pan pelletizer. In an embodiment, the colored agglomerated particles are dried in a fluid bed drying system. In the fluid bed drying system, hot air flows through a perforated plate that both dries the colored agglomerated particles and moves the colored agglomerated particles through the apparatus. In an embodiment, the fluid bed drying system comprises multiple heating zones and a final cooling zone.

According to an embodiment, the overall loading rate of the pigment can be from 1 wt % to 10 wt % based on the total mass of the dry material, with this loading rate varying by pigment strength.

According to an embodiment, the overall loading rate of the colored rock fines, the colored mineral fines, or a combination thereof can be from 1 wt % to 100 wt % based on the total mass of the dry material.

According to one embodiment, the overall amount of the binder in the process described above is typically 13 wt % based on the total dry mass. However, the overall amount of the binder in the process can include any of the various amounts of binder described above.

In one embodiment, the method further comprises drying the colored agglomerated particles.

In one embodiment, the method further comprises applying the colored agglomerated particles to a sheet to form a roofing product, as discussed further below.

D. Colored Roofing Granules, Roofing Materials, and/or Methods of Applying the Colored Agglomerated Particles to a Roofing Material

Another embodiment of this invention pertains to colored roofing granules comprised of agglomerated particles, including the above-discussed colored agglomerated materials. According to one embodiment, the colored roofing granule comprises colored agglomerated particles comprising (i) at least one of a rock, a mineral, or a combination thereof, (ii) at least one of a pigment, colored rock fines, colored mineral fines, or a combination thereof, and (iii) a binder. Another to another embodiment, the colored roofing granule comprises colored agglomerated particles comprising (i) at least one of a rock, a mineral, or a combination thereof, (ii) a waste pigment material comprising colored rock fines, colored mineral fines, or a combination thereof, and (iii) a binder.

In one embodiment, the colored rock fines, the colored mineral fines, or a combination of the colored rock fines and the colored mineral fines is obtained from a waste stream from granule painting operations (i.e., the colored rock fines, the colored mineral fines, or a combination thereof comprise waste pigment material).

In one embodiment, the colored agglomerated particles are unsintered.

In one embodiment, the colored agglomerated particles exhibit an L value, as measured by a Hunter L, a, and b color scale, that is from 20 to 30. In one embodiment, the colored agglomerated particles exhibit an a value, as measured by a Hunter L, a, and b color scale, that is from −2 to 0. In one embodiment, the colored agglomerated particles exhibit an a value, as measured by a Hunter L, a, and b color scale, that is from −1 to 0. In one embodiment, the colored agglomerated particles exhibit an a value, as measured by a Hunter L, a, and b color scale, that is from −0.5 to 0. In one embodiment, the colored agglomerated particles exhibit a b value, as measured by a Hunter L, a, and b color scale, that is from 0 to 2. In one embodiment, the colored agglomerated particles exhibit a b value, as measured by a Hunter L, a, and b color scale, that is from 0.5 to 2. In one embodiment, the colored agglomerated particles exhibit a b value, as measured by a Hunter L, a, and b color scale, that is from 1 to 2.

Another embodiment of this invention pertains to a roofing material (e.g., a roofing shingle) that includes colored roofing granules comprised of agglomerated particles, including the above-discussed colored agglomerated materials. Colored agglomerated particles may be applied to the back surface or front surface, including the buttlap and/or headlap of the shingle. In an embodiment, the colored agglomerated particles applied to the back surface, buttlap and/or headlap of the shingle have different particle size distributions. The choice of particle size distribution selected for a shingle surface may be influenced by the balance of surface coverage, shingle weight, degree of flatness and impact resistance required. The shingle may be a single-layer shingle or a laminated shingle.

According to one embodiment, a roofing material is provided that comprises colored agglomerated particles comprising (a) at least one of a rock, a mineral, or a combination thereof, (b) at least one of a pigment, colored rock fines, colored mineral fines, or a combination thereof, and (c) a binder. According to another embodiment, the roofing material comprises colored agglomerated particles comprising (a) at least one of a rock, a mineral, or a combination thereof, (b) a waste pigment material comprising colored rock fines, colored mineral fines, or a combination thereof, and (c) a binder.

In one embodiment, the colored rock fines, the colored mineral fines, or a combination of the colored rock fines and the colored mineral fines is obtained from a waste stream from granule painting operations (i.e., the colored rock fines, the colored mineral fines, or a combination thereof comprise waste pigment material).

In one embodiment, the colored agglomerated particles are unsintered.

Examples of a sheet that may be used to make the shingle are as follows. In particular, in an embodiment, the shingle may be formed from a fiberglass mat with an asphalt coating on both sides of the mat. In an embodiment, the shingle may be formed from organic felt or other types of base material, including synthetic mats or synthetic glass/hybrid mats having an appropriate coating. Non-limiting examples of coatings include asphalt and modified bituminous coatings based on atactic polypropylene (APP), styrene-butadiane-styrene (SBS), styrene-ethylene-butadiene-styrene (SEBS), amorphous polyalpha olefin (APAO), thermoplastic polyolefin (TPO), synthetic rubber or other asphaltic modifiers.

In an embodiment, two or more shingles are installed on a roof deck in a roofing system such that the shingles are in a row from left to right and the lateral edges of the shingles in the row are contiguous with each other so as to abut each other, i.e., their lateral edges are adjacent to one another. Each row represents a course and the shingles are applied in overlapping courses on the roof deck, wherein the buttlap portion of a subsequent course is placed on the headlap portion of a previous course. In an embodiment, the headlap portion of the shingle is at least as wide as the buttlap portion of the shingle so that when the shingles are installed on a roof deck in overlapping courses, the entire buttlap portion of a subsequent course has headlap beneath it. In an embodiment, an edge of the shingle has a plurality of dragon teeth with openings therebetween. In an embodiment of the laminated shingle, a backer strip is provided under the dragon teeth, with portions of the backer strip exposed through the openings between the dragon teeth. In an embodiment of the single layer shingle, when the shingle is installed on a roof deck, the dragon teeth of a second layer of shingles is placed on the headlap of a previously installed layer of shingles, such that portions of the headlap region are exposed through the openings between the dragon teeth.

One embodiment pertains to a roofing system comprising one or more shingles that comprise agglomerated particles, including the colored agglomerated particles discussed above.

In some embodiments, the invention relates to the method of applying agglomerated particles, including the colored agglomerated particles discussed above, to a roofing material (e.g., a roofing shingle). In some embodiments, the method includes application of the colored agglomerated particles to at least one of the back surface or front surface, including the buttlap or the headlap of the shingle. Manufacturing the shingle includes applying colored agglomerated particles to asphalt coated sheeting. The asphalt sheet is then pressed in a press roll unit, such that the colored agglomerated particles embed in the asphalt coating. The asphalt sheet is then cut to the desired shape on a machine line. In embodiments, the invention includes the method of making agglomerated particles, including the colored agglomerated particles discussed above, and applying the colored agglomerated particles to a shingle as detailed herein.

In one embodiment, the colored agglomerated particles are not sintered before being used. In other words, the colored agglomerated particles are, without being sintered, used to make a roofing material such as a shingle or roll roofing. As used herein “sintering” is the process of compacting and forming a solid mass of material by heat or pressure without melting it to the point of liquefaction.

The choice of particle size distribution selected for a shingle may be influenced by the balance of surface coverage, shingle weight, degree of flatness and impact resistance required.

According to embodiments of the invention described herein a colored roofing granule made from agglomerated rock fines and embedded pigment is prepared, with the ability to have the pigment permeate through the body of the roofing granule to thereby impart resilience to the color properties of the granule as the abraded surfaces will still be colored.

According to embodiments of the invention described herein a colored roofing granule made from agglomerated rock fines and embedded pigment is prepared using colored rock fines and/or colored mineral fines (i.e., colored rock fines and/or colored mineral fines that comprise waste pigment material), which provides a use for an otherwise problematic waste stream of colored fines from, e.g., a granule coloring plant.

### E. EXAMPLES

Specific embodiments of the invention will now be demonstrated by reference to the following examples. It should be understood that these examples are disclosed by way of illustrating the invention and should not be taken in any way to limit the scope of the invention.

### Example 1

Formulations for creating colored agglomerated particles were prepared using (a) dry constituents that included (i) a certain percentage of uncolored rock fines (e.g., basalt or metabasalt) and (ii) a certain percentage of pigment-containing or colored rock fines (i.e., black coloring plant fines), and (b) a sodium silicate liquid binder. The dry constituents of the formulations, which are described in Table 1 below, were combined with the sodium silicate binder in a pin-mixer to produce colored agglomerated particles.

TABLE 1

| | | Wt % Pigment- |
|---|---|---|
| | | Containing Fines |
| | Wt % Rock Fines | (black coloring |
| | (uncolored) | plant fines) |
| Example Formulation 1 | 93.7 | 6.3 |
| Example Formulation 2 | 82.7 | 17.3 |
| Example Formulation 3 | 71.7 | 28.3 |

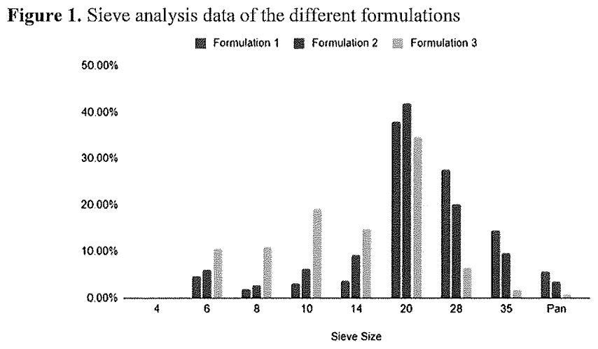

FIG. 1 illustrates the results of this example by showing the percent yield (or percentage retained) over certain sieve sizes (Tyler Mesh) of the three formulations of colored agglomerated particles described above. Thus, as shown in FIG. 1, the colored agglomerated particles, which are prepared from the formulations described above, are retained by at least Tyler Mesh 6, with over 30% being retained by Tyler Mesh 20.

### Example 2

Using the colored agglomerated particles prepared from the formulations described in Example 1 above, color is measured using the Hunter L, a, and b color scale, utilizing a HunterLab Lab Scan XE Colorimeter (HunterLab, Reston, Va.). Color is expressed as L, a, and b values. The L value indicates the “lightness” and ranges from 0 to 100, or black to white, respectively. The a- and b-values indicate the “off white” shades and quantify the green to red and blue to yellow scales, respectively. The value for color is dimensionless (i.e., has no units).

Granule color is measured on a flat bed of granules dispersed in a shallow container. The granules are dispersed in a shallow container by tamping a pile of the material into a compacted, level surface.

The measured values for color (using HunterLab) of the exemplary colored agglomerated particles prepared from the formulations described in Example 1 above is given in Table 2 below.

TABLE 2

| | Example | Example | Example |
|---|---|---|---|
| | Formulation 1 | Formulation 2 | Formulation 3 |
| L | 28.9 | 22.5 | 19.3 |
| A | −1.3 | −0.5 | −0.3 |
| b | 1.8 | 0.8 | 0.3 |

Thus, as shown in Table 2 above, the colored agglomerated particles, which are prepared from the formulations described in Example 1 above, exhibit suitable color properties for L, a, and b.

By way of reference, below is a table, Table 3, showing the correspondence between US Mesh, Tyler Mesh, and the sieve opening size in inches and micrometers:

TABLE 3

| | |
|---|---|
| ISO Standard | Opening |

| | | |
|---|---|---|
| Sieve Size | inches (in) | Standard Mesh |

| | | | | |
|---|---|---|---|---|
| mm or μm as | approximate | | US | Tyler |
| indicated | equivalents | mm | Mesh | Mesh |

| | | | | | |
|---|---|---|---|---|---|
| 5.60 | mm | 0.2230 | 5.600 | 3.5 | 3.5 |
| 4.75 | mm | 0.1870 | 4.750 | 4 | 4 |
| 4.00 | mm | 0.1570 | 4.000 | 5 | 5 |
| 3.35 | mm | 0.1320 | 3.350 | 6 | 6 |
| 2.80 | mm | 0.1100 | 2.800 | 7 | 7 |
| 2.36 | mm | 0.0937 | 2.360 | 8 | 8 |
| 2.00 | mm | 0.0787 | 2.000 | 10 | 9 |
| 1.70 | mm | 0.0661 | 1.700 | 12 | 10 |
| 1.40 | mm | 0.0555 | 1.400 | 14 | 12 |
| 1.18 | mm | 0.0469 | 1.180 | 16 | 14 |
| 1.00 | mm | 0.0394 | 1.000 | 18 | 16 |
| 850 | μm | 0.0331 | 0.850 | 20 | 20 |
| 710 | μm | 0.0278 | 0.710 | 25 | 24 |
| 600 | μm | 0.0234 | 0.600 | 30 | 28 |
| 500 | μm | 0.0197 | 0.500 | 35 | 32 |
| 425 | μm | 0.0165 | 0.425 | 40 | 35 |
| 355 | μm | 0.0139 | 0.355 | 45 | 42 |
| 300 | μm | 0.0117 | 0.300 | 50 | 48 |
| 250 | μm | 0.0098 | 0.250 | 60 | 60 |
| 212 | μm | 0.0083 | 0.212 | 70 | 65 |
| 180 | μm | 0.0070 | 0.180 | 80 | 80 |
| 150 | μm | 0.0059 | 0.150 | 100 | 100 |
| 125 | μm | 0.0049 | 0.125 | 120 | 115 |
| 106 | μm | 0.0041 | 0.106 | 140 | 150 |
| 90 | μm | 0.0035 | 0.090 | 170 | 170 |
| 75 | μm | 0.0029 | 0.075 | 200 | 200 |
| 63 | μm | 0.0025 | 0.063 | 230 | 250 |
| 53 | μm | 0.0021 | 0.053 | 270 | 270 |
| 45 | μm | 0.0017 | 0.045 | 325 | 325 |
| 38 | μm | 0.0015 | 0.038 | 400 | 400 |
| 32 | μm | 0.0012 | 0.032 | 450 | |
| 25 | μm | 0.0010 | 0.025 | 500 | |
| 20 | μm | 0.0008 | 0.020 | 635 | |

As discussed above, one example of rock and/or mineral is basalt; however, metabasalt (which is an amphibolite produced from the metamorphism of the basalt parent) may be used in addition to or instead of basalt. In other words, where the embodiments use the term basalt, they should be read as describing the use of basalt, metabasalt, or a combination of basalt and metabasalt.

Although the invention has been described in certain specific exemplary embodiments, many additional modifications and variations would be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

1. A method comprising:
obtaining (i) at least one of rock fines, mineral fines, or a combination thereof, (ii) a waste pigment material comprising colored rock fines, colored mineral fines, or a combination thereof, and (iii) a binder; and
mixing (i) the at least one of rock fines, mineral fines, or a combination thereof, (ii) the waste pigment material, and (iii) the binder, to produce colored agglomerated particles.

2. The method according to claim 1, wherein the waste pigment material is obtained from a waste stream from granule painting operations.

3. The method according to claim 1, wherein the waste pigment material is added at a loading rate of 1 wt % to 100 wt % based on a dry mass of the colored agglomerated particles.

4. The method according to claim 1, wherein the waste pigment material comprises at least one of (i) clay materials, (ii) rock fines, mineral fines, or a combination thereof, (iii) one or more pigments, (iv) silicates, or (v) a combination thereof.

5. The method according to claim 1, wherein the waste pigment material comprises from 1 wt % to 10 wt % of at least one of sodium (Na), magnesium (Mg), aluminum (Al), or silicon (Si).

6. The method according to claim 1, wherein the at least one of rock fines, mineral fines, or a combination thereof is added in an amount of 50 wt % to 95 wt % with respect to a total dry weight of the colored agglomerated particles.

7. The method according to claim 1, wherein the at least one of rock fines, mineral fines, or a combination thereof comprises one or more of basalt, metabasalt, andesite, granite, and rhyolite.

8. The method according to claim 1, wherein the binder is at least one of sodium silicate, gypsum, or a combination thereof.

9. The method according to claim 1, wherein the binder is added in an amount of 1 wt % to 15 wt % with respect to a total weight of the colored agglomerated particles.

10. The method according to claim 1, wherein the method further comprises adding a pigment to the colored agglomerated particles.

11. The method according to claim 1, wherein the method further comprises applying the colored agglomerated particles to a sheet to form a roofing material.

12. A colored roofing granule comprising
colored agglomerated particles comprising:
(i) at least one of a rock, a mineral, or a combination thereof,
(ii) a waste pigment material comprising colored rock fines, colored mineral fines, or a combination thereof, and
(iii) a binder.

13. The colored roofing granule according to claim 12, wherein the waste pigment material is obtained from a waste stream from granule painting operations.

14. The colored roofing granule according to claim 12, wherein the waste pigment material is present in an amount of 1 wt % to 100 wt % with respect to a total dry weight of the colored agglomerated particles.

15. The colored roofing granule according to claim 12, wherein the waste pigment material comprises at least one of (i) clay materials, (ii) rock fines, mineral fines, or a combination thereof, (iii) one or more pigments, (iv) silicates, or (v) a combination thereof.

16. The colored roofing granule according to claim 12, wherein the colored agglomerated particles exhibit an L value, as measured by a Hunter L, a, and b color scale, that is from 20 to 30.

17. A roofing material comprising colored agglomerated particles comprising:
(a) at least one of a rock, a mineral, or a combination thereof;
(b) a waste pigment material comprising colored rock fines, colored mineral fines, or a combination thereof; and
(c) a binder.

18. The roofing material according to claim 17, wherein the waste pigment material is obtained from a waste stream from granule painting operations.

19. The roofing material according to claim 17, wherein the waste pigment material comprises at least one of (i) clay materials, (ii) rock fines, mineral fines, or a combination thereof, (iii) one or more pigments, (iv) silicates, or (v) a combination thereof.

20. The roofing material according to claim 17, wherein the roofing material comprises a roofing shingle or roll roofing.
